(19) United States
(12) Patent Application Publication
(10) Pub. No.: US 2010/0267332 A1
(43) Pub. Date: Oct. 21, 2010

(54) Wireless Audio/Video System with Remote Playback and Control

(76) Inventor: Wai-Fong Lui, Hong Kong (CN)

Correspondence Address: ALIX YALE & RISTAS LLP, 750 MAIN STREET, SUITE 1400, HARTFORD, CT, 06103, US

(21) Appl. No.: 12/224,932

(22) PCT Filed: Mar. 8, 2007
(86) PCT No.: PCT/CN2007/000744

§ 371 Date: Jun. 14, 2010

(30) Foreign Application Priority Data
Mar. 8, 2006 (HK) 06102988.4

(51) Int. Cl. H04H 40/00

(52) U.S. Cl. 455/3.06

(57) ABSTRACT

A wireless audio/video system with remote playback and control comprises a main system unit and a portable control and playback device. The main system unit comprises a wireless reception sub-system for receiving audio and video signals, an audio/video signal processing sub-system for processing signals received by said wireless reception sub-system, an audio/video output sub-systems for retransmitting said audio/video signals, one or more audio power amplifiers for amplifying said audio signals, and an input signal selection system for receiving control signals from a remote device. The portable control and playback device comprises a program material storage sub-system, a program material playback sub-system for playing material stored in said program material storage sub-system, a main system unit control sub-system, and a wireless transmission sub-system.

### BACKGROUND OF THE INVENTION

The present invention relates to wireless audio/video systems. More particularly, although not exclusively, the invention relates to such a system including a handheld unit for receiving and transmitting audio/video signals and control signals.

Known domestic entertainment systems include a signal source such as a DVD player or cable/satellite receiver, a display monitor, separate surround sound amplifiers and separate remote-control units. A problem with such systems lies in the requirement for multiple cable connections between the various system components.

### OBJECTS OF THE INVENTION

It is an object of the present invention to overcome or substantially ameliorate the above disadvantage and/or more generally to provide an improved wireless audio/video system with remote playback and control.

### DISCLOSURE OF THE INVENTION

There is disclosed herein a wireless audio/video system with remote playback and control, comprising:
a main system unit, comprising:
   a wireless reception sub-system for receiving audio and video signals,
   an audio/video signal processing sub-system for processing signals received by said wireless reception sub-system,
   audio/video output sub-systems for retransmitting said audio/video signals,
   one or more audio power amplifiers for amplifying said audio signals, and
   an input signal selection system for receiving control signals from a remote device, and
a portable control and playback device, comprising:
   a program material storage sub-system,
   a program material playback sub-system for playing material stored in said program material storage sub-system,
   a main system unit control sub-system, and
   a wireless transmission sub-system for transmitting signals from the main system control unit to said wireless reception sub-system of the main system unit.

Typically, the portable control and playback device is configured as a satellite control and playback device and acts as a repeater for the wireless signal transmitted from another portable control and playback device which has been set as a master unit or to enable multiple users for one system, or to extend wireless transmission range so that a plurality of users can be included in a wireless audio video network.

Typically, said satellite portable control and playback device is configured to send request signals to the master portable control and playback device, and wherein the master device is configured to set the system to playback audio and video signals transmitted from said satellite portable control and playback device, thereby operating as a wireless conference system with audio and video capability.

Typically, said portable control and playback device further comprises a video display system.

Typically, said portable control and playback device further comprises an audio playback system.

Typically, said portable control and playback device further comprises a wireless receiving sub-system for receiving wireless signals from other portable control and playback devices.

### BRIEF DESCRIPTION OF THE DRAWINGS

Preferred forms of the present invention will now be described by way of example with reference to the accompanying drawings, wherein:

FIG. 1 is a block diagram of a basic audio/video system with a remote playback feature, and

FIG. 2 is a block diagram of a more advanced audio/video system.

### DESCRIPTION OF THE PREFERRED EMBODIMENTS

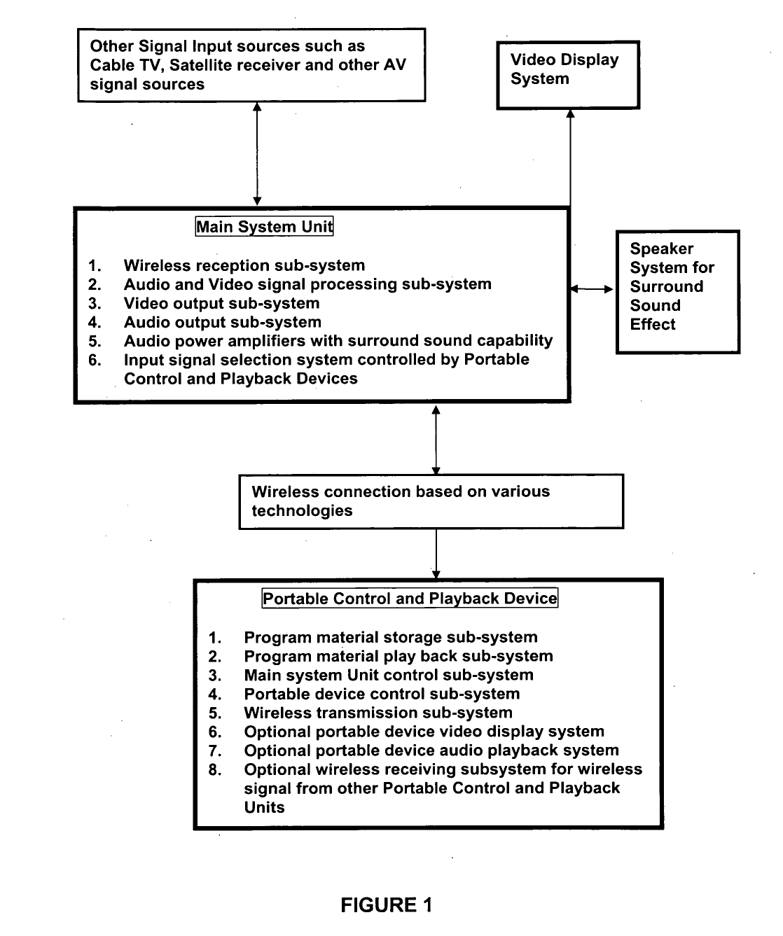

In FIG. 1 of the accompanying drawings there is depicted schematically a portable control and playback device that might include a built-in program storage and playback unit, such as a DVD player or hard disk player, an audio video system control unit and a wireless communication device. Optionally, the portable control and playback device would not include a built-in program storage and playback device, but would instead receive signals from a remote audio/video program source such as a DVD player, satellite tuner, cable TV receiver, digital terrestrial set-top box or the like.

The system contains a main system unit with built-in wireless reception means, signal decoding means, a display device and amplifiers for external speakers.

The portable control and playback device may integrate a means for displaying system status, program information and playback status.

The wireless transmission means in the portable control and playback device is capable of transmitting audio and video signals of a program being played and control signals for the audio video system. Signal transmission might be by wireless means such as radio frequency RF, infra-red IR beam, or household electric power line for example.

Users of this system can take the portable control and playback device to a location away from the main system unit such as the sitting room sofa and retain full and complete control over the choice of program source, selection of program materials, video, surround sound and audio level without physically approaching the audio video system as is required with audio video systems currently available in the market. The main system unit receives the program signal and system control signal from the portable control and playback device via wireless transmission and then processes such signal to provide audio and video information required by the user.

The video signal output from the system is sent to the display device and the audio signal is supplied to the speakers either via conventional wired connection or by wireless transmission.

Users of the above portable control playback device will have full control of playback program and setting of the system, such as loading and unloading a program disc, remotely without physically approaching the audio video system, which is required in current audio video systems.

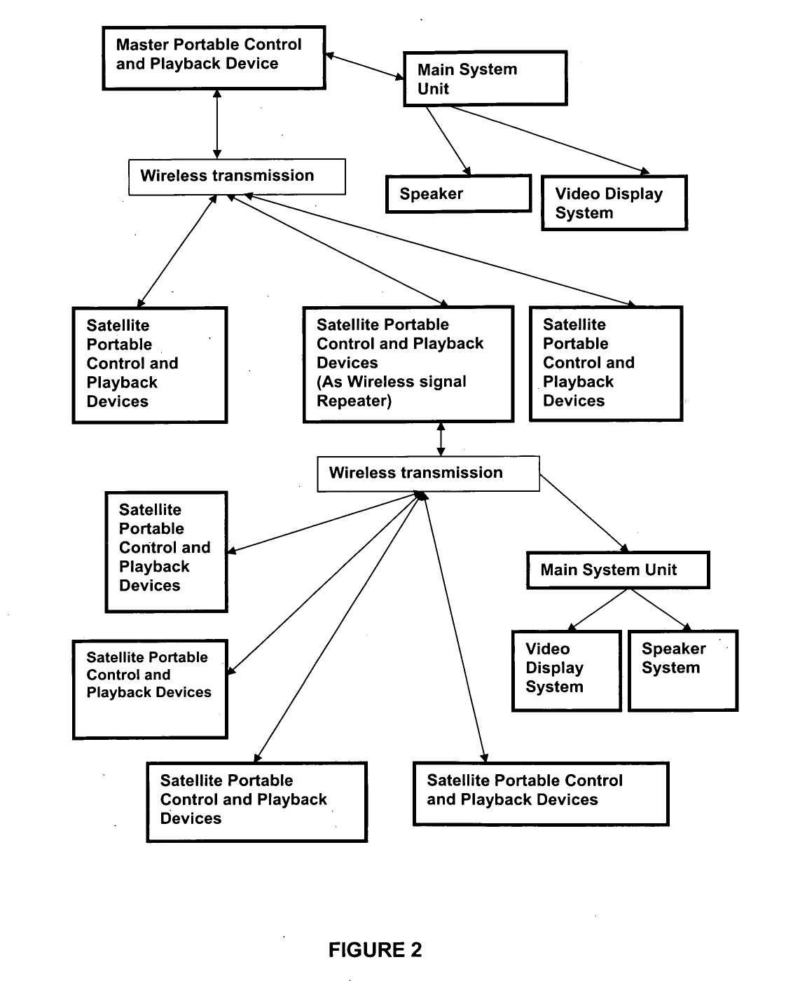

In FIG. 2 of the accompanying drawings there is depicted schematically a more advanced system comprising of multiple portable control and playback devices working with one or more main system devices. One of the portable control and playback devices will be the master unit of the system. Audio video signals from this master portable control and playback device is transmitted to the main system unit and other portable control and playback devices simultaneously. The main system unit and all other portable control and playback devices will display the audio and video signal of the program that the master control and playback device is playing.

Some of the portable control and playback devices can be configured as satellite units to receive the wireless transmission signal from the master unit and the display unit on the portable control and playback device will be configured to playback the audio and video signals received from the master unit.

Some of the satellite portable control and playback devices can be configured into wireless signal repeaters to retransmit the received audio and video signal to other far away portable control and playback devices.

In this mode of operation, the portable control and playback devices that are not operating as the master unit can be configured to act as wireless signal repeaters to retransmit the wireless signal broadcasted by the master unit thereby extending the range and the number of portable control and playback devices that can be incorporated into the system.

Users of the satellite portable control and playback devices can, from time to time, transmit a certain control signal to be received by the master portable control and playback device. This control signal can constitute a request from users of the satellite portable control and playback device for certain activities to be granted by the user of the master unit who can then make decision to set either the master portable control and playback device or the main system unit to playback the program signal from the satellite portable control and playback device. Under this mode of operation, the advance system can be used as a conference system with audio and video capability.

Transmission of program material and system control signals from the portable control and playback device can also be used by other portable control and playback devices and multiple main systems for multiple users in the same or different locations as a means of audio video system for multiple rooms or as a means of broadcasting of audio video signal to multiple users.

It should be appreciated that modifications and alterations obvious to those skilled in the art are not to be considered as beyond the scope of the present intention.

1. A wireless audio/video system with remote playback and control, comprising:
a main system unit, comprising:
a wireless reception sub-system for receiving audio and video signals,
an audio/video signal processing sub-system for processing signals received by said wireless reception sub-system,
audio/video output sub-systems for retransmitting said audio/video signals,
one or more audio power amplifiers for amplifying said audio signals, and
an input signal selection system for receiving control signals from a remote device, and
a portable control and playback device, comprising:
a program material storage sub-system,
a program material playback sub-system for playing material stored in said program material storage sub-system,
a main system unit control sub-system, and
a wireless transmission sub-system for transmitting signals from the main system control unit to said wireless reception sub-system of the main system unit.

2. The system of claim 1, wherein the portable control and playback device is configured as a satellite control and playback device and acts as a repeater for the wireless signal transmitted from another portable control and playback device which has been set as a master unit or to enable multiple users for one system, or to extend wireless transmission range so that a plurality of users can be included in a wireless audio video network.

3. The system of claim 2, wherein a said satellite portable control and playback device is configured to send request signals to the master portable control and playback device, and wherein the master device is configured to set the system to playback audio and video signals transmitted from said satellite portable control and playback device, thereby operating as a wireless conference system with audio and video capability.

4. The system of claim 1, wherein said portable control and playback device further comprises a video display system.

5. The system of claim 1, wherein said portable control and playback device further comprises an audio playback system.

6. The system of claim 1, wherein said portable control and playback device further comprises a wireless receiving sub-system for receiving wireless signals from other portable control and playback devices.
